(19) United States
(12) Patent Application Publication
(10) Pub. No.: US 2020/0108282 A1
(43) Pub. Date: Apr. 9, 2020

(54) PARTICULATE PROTECTIVE ARTICLES

(71) Applicant: HONEYWELL INTERNATIONAL INC., Morris Plains, NJ (US)

(72) Inventors: Alan Warren SCHIERENBECK, Morris Plains, NJ (US); Katherine Elizabeth BLAUSER, Morris Plains, NJ (US); Lisa CUBAS RAY, Morris Plains, NJ (US); Jeffrey REED, Morris Plains, NJ (US); Jim WALTER, Morris Plains, NJ (US)

(21) Appl. No.: 16/153,049

(22) Filed: Oct. 5, 2018

(51) Int. Cl. A62B 17/00; A41D 13/05; A41D 29/00; A41B 9/00; A41B 17/00

(52) U.S. Cl. CPC A62B 17/006; A41D 13/0525; A41D 13/0518; A41D 13/0512; A41D 13/0537; A41D 2600/20; A41B 9/001; A41B 17/00; A41D 13/05; A62B 17/003; A41D 29/00

(57) ABSTRACT

Apparatuses and associated methods of manufacturing are described that provide a particulate protective article. An example particulate protective article includes one or more structural sections that are formed of a primary material and one or more protective sections connected with the one or more structural sections so as to form an article of clothing. Each protective section is formed of a particulate blocking or filtering material. In an instance in which the article is worn by a user, the one or more protective sections shield one or more corresponding areas of the user's superficial lymphatic system from particulate matter. In some embodiments, the article is formed as a shirt so as to shield the torso, armpits, and/or neck of the user. In other embodiments, the article is formed as an undergarment so as to shield the groin, lower abdomen, and/or buttocks of the user.

### TECHNOLOGICAL FIELD

Example embodiments of the present invention relate generally to protective articles and garments and, more particularly, to reducing exposure to particulate substances.

### BACKGROUND

Fire response personnel, law enforcement, emergency medical service personnel (EMS), military personnel, law enforcement, and the like are often exposed to particulate substances and matter while performing their active duties. By way of example, particulates resulting from combustion, Toxic Industrial Compounds (TICs), and/or Volatile Organic Compounds (VOCs), some or all of which may be carcinogenic or otherwise harmful to the personnel, may be regularly encountered in these careers. Contact with these particulates may pose an immediate threat (e.g., due to lethal dosage) and/or long term threat (e.g., due to buildup of the particulates in body tissue) to these personnel. The inventors have identified numerous other deficiencies with existing technologies in this field, the remedies for which are the subject of the embodiments described herein.

### BRIEF SUMMARY

The present disclosure relates to a particulate protective article and associated method of manufacturing. An example particulate protective article may include one or more structural sections that are formed of a primary material. In some embodiments, the primary material may be melt-resistant. The article may further include one or more protective sections connected with the one or more structural sections so as to form an article of clothing. Each protective section may be formed of a particulate blocking or filtering material. In an instance in which the article is worn by a user, the one or more protective sections may be configured to shield one or more corresponding areas of the user's superficial lymphatic system from particulate matter.

In some embodiments, the article may be formed as a shirt configured to at least partially cover the user's torso. In such an embodiment, the one or more protective sections may be located so as to shield a front portion of the user's torso from particulate matter. In other such embodiments, the one or more protective sections may also be located so as to shield the user's armpits from particulate matter. Still further, in some cases, the one or more protective sections may be located so as to shield the user's neck from particulate matter.

In some embodiments, the article is formed as an undergarment configured to at least partially cover the user's groin. In such an embodiment, the one or more protective sections may be located so as to shield the user's groin and lower abdomen from particulate matter. In other such embodiments, the one or more protective sections may be located so as to shield at least a portion of the user's buttocks from particulate matter.

In any such embodiment, the particulate protective article may be configured to interface with one or more additional articles of clothing so as to form a protective uniform.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIGS. 1A-1B illustrate a front and back view, respectively, of a particulate protective shirt with neck protection according to an example embodiment.

FIGS. 2A-2B illustrate a front and back view, respectively, of a particulate protective shirt with armpit and torso protection according to an example embodiment.

FIGS. 3A-3B illustrate a front and back view, respectively, of a particulate protective shirt with torso protection according to an example embodiment.

FIGS. 4A-4B illustrate a front and back view, respectively, of a particulate protective undergarment with groin, lower abdomen, and buttocks protection according to an example embodiment.

FIGS. 5A-5B illustrate a front and back view, respectively, of a particulate protective undergarment with groin and lower abdomen protection according to an example embodiment.

FIGS. 6A-6B illustrate a front and back view, respectively, of a particulate protective undergarment with groin protection according to an example embodiment.

### DETAILED DESCRIPTION

### Overview

The present invention now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. As used herein, terms such as “front,” “rear,” “back,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances. As discussed herein, example embodiments may be described with reference to a shirt, undergarment, or similar article of clothing. However, the present disclosure may be equally applicable for use with any article, garment, covering, or the like (e.g., uniform shirt, overall, coverall, T-shirt, collar placket shirt, jacket, hood, undergarments, and the like) without limitation.

As noted above particulate protective articles and associated methods of manufacturing are described herein that provide solutions to the problems identified above, as well as others. Exposure to particulates (e.g., carcinogens, powdered drugs, chemical weapons, TICs, and/or VOCs) poses an immediate threat and ongoing threat to, for example, EMS, fire response, and law enforcement personnel. While each of these industries provide clothing and other gear adapted to their selected occupation (e.g., turnout gear for fire fighters), these items fail to provide sufficient protection from ingress of particulate substances/matter. For example, daily work uniforms, undergarments, and the like fail to provide protection from sub-micron to micro sized particulate hazards that may pass through standard working attire. Furthermore, particular areas of the body are more susceptible to particulate hazards due to the concentration of lymph nodes and/or glands at these areas. These areas of concentrated glands may also be located in areas in which conventional clothing interfaces or is otherwise left open (e.g., the waistline between a user's shirt and pants). Accordingly, the articles of the present application operate to reduce or otherwise eliminate exposure of a user's superficial lymphatic system to particulate hazards by utilizing protective sections configured to shield corresponding areas of a user's (e.g., a person wearing the article) superficial lymphatic system.

### Particulate Protective Article

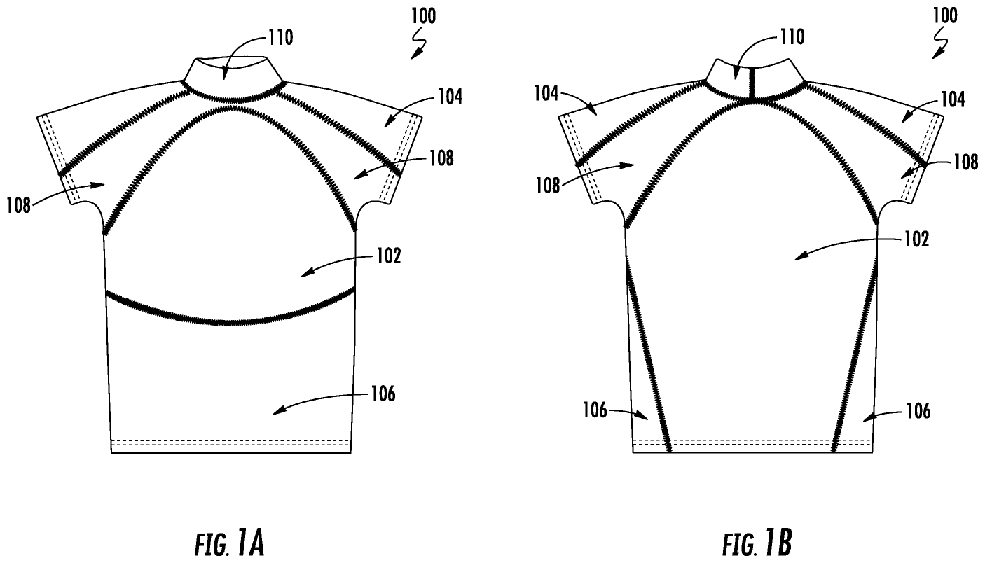

With reference to FIGS. 1A-1B, a front view and a back view, respectively, of a particulate protective shirt 100 are illustrated. As shown, the particulate protective shirt 100 may include one or more structural sections (e.g., chest section(s) 102, shoulder sections 104, etc.) each of which may be comprised of a primary material. As would be evident to one of ordinary skill in the art in light of the present disclosure, the primary material used for the structural sections (e.g., chest section(s) 102 and shoulder sections 104) may be any suitable material for use with uniforms, shirts, jackets, or the like (e.g., cotton, polyester, etc.) In some embodiments, the primary material may be comprised of a melt-resistant material so as to prevent adhesion, due to increased temperatures, of the primary material to a user's skin. By way of example, fire response personnel are often subjected to increased temperatures (e.g., wildfires or the like) and may be burned in the performance of their duties. As such, in some embodiments, the primary material may be configured to be melt-resistant so as to prevent the structural sections from melting to the skin of the user in extreme heat conditions.

As shown, these structural sections may be disposed at locations in which exposure to particulate hazards are lower. By way of example, in an instance in which the particulate protective shirt 100 is worn by a user, the chest section 102 and the shoulder sections 104 may be located in areas not associated with the superficial lymphatic system. As such, these areas may be covered by the structural elements of the chest section 102 and the shoulder sections 104 comprised of the primary material. While illustrated with structural sections located at the chest section 102 (e.g., that also wraps around a user and covers a user's back as shown in FIG. 1B) and the shoulder sections 104, the present disclosure contemplates that any number of different designs, patterning, etc. of the structural sections may be used based upon the implementation of the particulate protective shirt 100. By way of example, if additional support (e.g., a heavier weight fabric, additional stitching, etc.) are needed for an application of the particulate protective shirt 100, the structural sections may be dimensioned (e.g., sized and shaped) so as to provide additional support for said application. Furthermore, the present disclosure contemplates that the one or more structural sections (e.g., chest section(s) 102 and shoulder sections 104) may be modified for aesthetic appeal. By way of example, the one or more structural sections may be contoured, dimensioned (e.g., sized and shaped), colored, etc. so as to accommodate a particular design, logo, or the like.

With continued reference to FIGS. 1A-1B, the particulate protective shirt 100 may also include one or more protective sections (e.g., torso section 106, armpit section 108, and neck section 110). The one or more protective sections may be comprised of a particulate blocking or filtering material configured to prevent transmission of particulate substances or matter therethrough. In some embodiments, this material may be a tri-layer, particulate filtering, and woven material. As shown in the particulate protective shirt 100 of FIG. 1A-1B, the torso section 106 may, in an instance in which the particulate protective shirt 100 is worn by a user, shield the high concentration of lymph nodes and glands (e.g., the superficial lymphatic system) of the torso. Furthermore, the torso sections 106 may also function to shield the ingress of particulate hazards common at locations at which articles interface. By way of example, the particulate protective shirt 100 may be worn as an undershirt that is further covered by a protective coat and worn in conjunction with protective trousers (e.g., a firefighter's turnout gear). In such an example, the interface between the protective coat and the protective trousers may be a location in which the ingress of particulate hazards is more likely. As such, the particulate protective shirt 100 of the present application may include a torso section 106 located at this interface so as to shield the superficial lymphatic system of the user at this location.

In some embodiments, the one or more protective sections may include an armpit section 108 configured to shield the superficial lymphatic system at the user's armpits from particulate matter and a neck section 110 configured to shield the superficial lymphatic system located at a user's neck from particulate matter. As described above with reference to a user's torso, a high concentration of lymph nodes proximate the surface of a user's skin as well as a high concentration of sweat glands are present at these locations. As such, the particulate protective shirt 100 of the present application includes protective sections at these locations to prevent the ingress of particulate hazards at these locations. Similar to the location of the torso section 106, the armpit section 108 and the neck section 110 may also be located at an interface between articles of clothing (e.g., gloves, hood, helmet, etc.). As such, the armpit section 108 and the neck section 110 may operate to shield the user's lymph nodes and sweat glands at these interface locations. While the armpit sections 108 are illustrated as a single section attached to the structural sections, the present disclosure contemplates that the armpit section 108 may be configured as underarm gussets, single or multi-piece, inset sleeves, raglan sleeves, dolman sleeves, or the like. Furthermore, while the neck section 110 is illustrated as a single section attached to the structural sections, the present disclosure contemplates that the neck section 110 may be configured as a stand collar, a mock neck, a turtleneck, or the like.

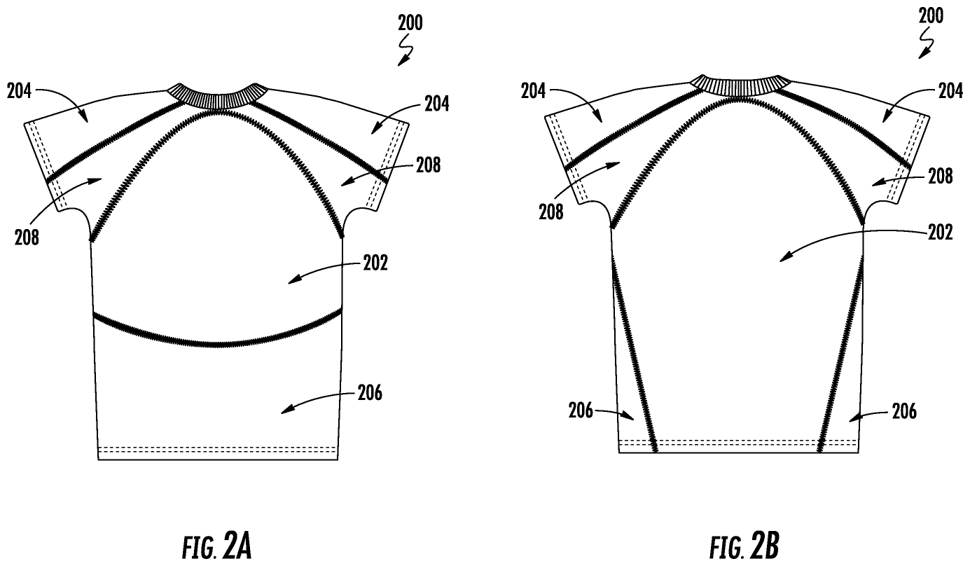

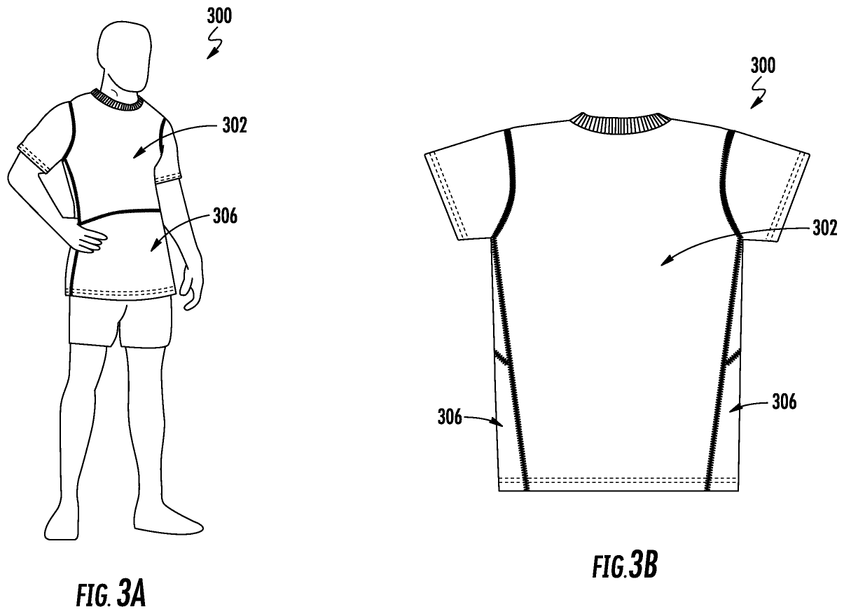

With reference to FIGS. 2A-2B and 3A-3B, alternative particulate protective articles 200 and 300 (e.g., formed as shirts) are illustrated. As shown in FIGS. 2A-2B, in some embodiments the particulate protective shirt 200 may include similar structural sections to the particulate protective shirt 100 (e.g., chest section(s) 202 and shoulder sections 204), but may only include protective sections for the torso (e.g., torso section 206) and the armpits (e.g., armpit section 208). As would be evident to one of ordinary skill in the art in light of the present disclosure, in some applications, the superficial lymphatic system of a user's neck may be at a relatively lower risk of particulate hazards. By way of example, a uniform that does not require a hood or helmet may similarly also not require a neck section 110 comprised of a particulate blocking or filtering material. Similarly, as shown in FIGS. 3A-3B, in some embodiments the particulate protective shirt 300 may include similar structural sections to the particulate protective shirt 100 (e.g., chest section(s) 302), but may only include protective sections for the torso (e.g., torso section 306). As above, in some applications, the superficial lymphatic system of a user's armpits may be at a relatively lower risk of particulate hazards. By way of example, a uniform that includes a protective jacket with particulate protective material therein may render the armpit sections of FIGS. 1A-2B unnecessary or redundant. So as to simplify the design of the particulate protective shirt 300, only a torso section 306 may be used to shield the superficial lymphatic system of the user's torso.

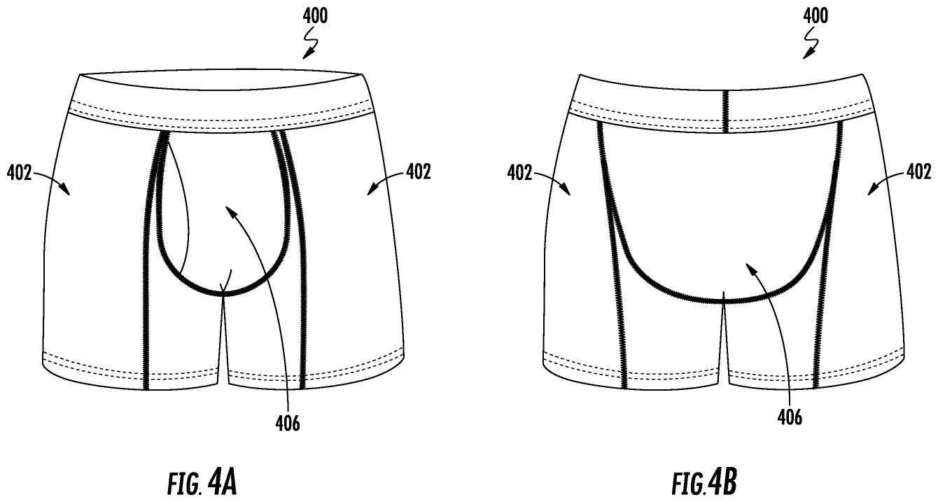

With reference to FIGS. 4A-4B, a front view and a back view, respectively, of a particulate protective undergarment 400 are illustrated. As shown, the particulate protective undergarment may include one or more structural sections (e.g., leg section(s) 402) each of which may be comprised of a primary material. As described above with reference to the particulate protective shirt 100, the primary material used for the structural sections (e.g., leg sections 402) may be formed of any suitable material for use with uniforms, pants, undergarments, or the like (e.g., cotton, polyester, etc.) In some embodiments, the primary material may be comprised of a melt-resistant material so as to prevent adhesion, due to increased temperatures, of the primary material to a user's skin.

As shown, these structural sections may be disposed at locations in which exposure to particulate hazards are lower. By way of example, in an instance in which the particulate protective undergarment 400 is worn by a user, the leg sections 402 may be located in areas not associated with the superficial lymphatic system (e.g., the exterior of the leg). As such, these areas may be covered by the structural elements of the leg sections 402 comprised of the primary material. While illustrated with structural sections located at the leg sections 402, the present disclosure contemplates that any number of different designs, patterning, etc. of the structural sections may be used based upon the implementation of the particulate protective undergarment. By way of example, if additional support (e.g., a heavier weight fabric, additional stitching, etc.) are needed for an application of the particulate protective undergarment 400, the structural sections may be dimensioned (e.g., sized and shaped) so as to provide additional support for the application. Furthermore, the present disclosure contemplates that the one or more structural sections (e.g., leg sections 402) may be modified for aesthetic appeal. By way of example, the one or more structural sections may be contoured, dimensioned (e.g., sized and shaped), colored, etc. so as to accommodate a particular design, logo, or the like.

With continued reference to FIGS. 4A-4B, the particulate protective undergarment 400 may also include one or more protective sections 406. The one or more protective sections may be comprised of a particulate blocking or filtering material configured to prevent transmission of particulate substances or matter therethrough. In some embodiments, this material may be a tri-layer, particulate filtering, and woven material. As shown in the particulate protective undergarment 400 of FIG. 4A-4B, the protective section 406 may, in an instance in which the particulate protective undergarment 400 is worn by a user, shield the high concentration of lymph nodes and glands (e.g., the superficial lymphatic system) of the groin, lower abdomen, and buttocks. As would be evident to one of ordinary skill in the art in light of the present disclosure, the number and location of the protective section(s) 406 may be adjusted based upon the application of the particulate protective undergarment. As shown in FIGS. 4A-4B, the protective sections 406 extend, on a front surface, from the waistband of the undergarment 400 along the lower abdomen and across the groin and inner thighs bounded by the leg sections 402. On a rear/back surface, the protective sections 406 extend to shield the buttocks.

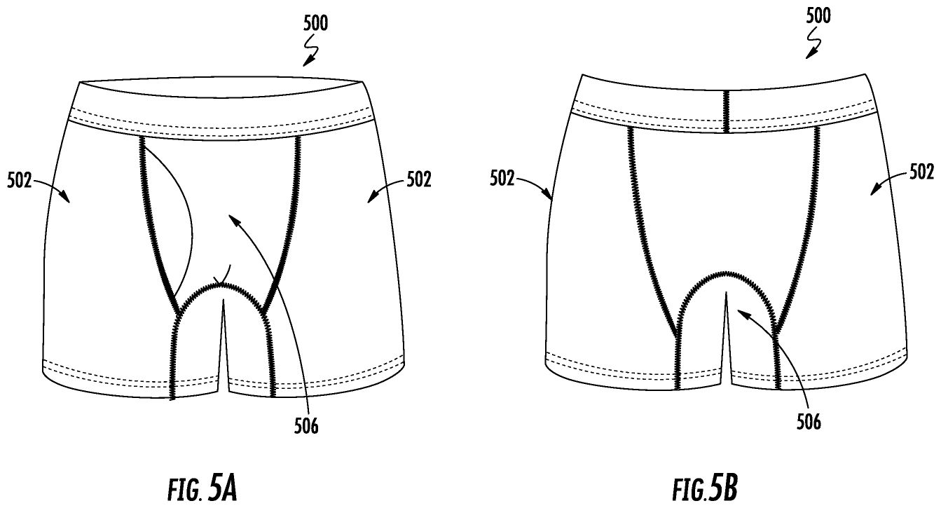

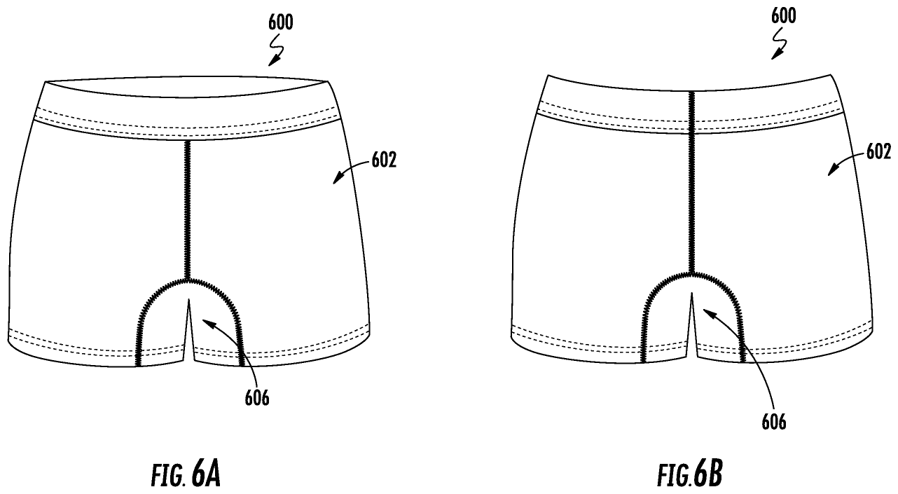

With reference to FIGS. 5A-5B and 6A-6B, alternative particulate protective articles 500 and 600 (e.g., formed as undergarments) are illustrated. As shown in FIGS. 5A-5B, in some embodiments the particulate protective undergarment 500 may include similar structural sections to the particulate protective undergarment 400 (e.g., leg section(s) 502), but may only include protective sections 506 for the lower abdomen and groin (e.g., not for the buttocks). Similarly, as shown in FIGS. 6A-6B, in some embodiments the particulate protective undergarment 600 may include similar structural sections to the particulate protective undergarment 400 (e.g., leg sections 602), but may only include protective sections 606 for the groin. As described above, the location, number, and structure of the protective sections 406, 506, and 606 may be configured so as to shield the superficial lymphatic system of the user (e.g., taking into account anatomical considerations).

As would be evident to one of ordinary skill in the art, the articles of the present application may be further configured to be mesh with, connect to, or otherwise interface with one or more additional articles of clothing so as to form a protective uniform. By way of example, the particulate protective shirt 100 may be configured to attach to an outer protective jacket, be received by protective trousers, and/or attach to the particulate protective undergarment 400. In this way, the articles of the present application may be adaptable to accommodate applications requiring varying levels of protection from particulate hazards. Furthermore, by targeting the areas of a user's body associated with the superficial lymphatic system (e.g., high concentrations of lymph nodes, glands, etc.), the articles of the present disclosure provide improved breathability, portability, and durability without compromising the particulate protection described herein. For example, an article comprised solely of a particulate filtering or blocking material may, in some instances, prove to lack the breathability required in certain applications (e.g., responding to a wildfire). Furthermore other materials (e.g., thick films and the like) fail to provide the required breathability for certain applications and/or further create auditory issues (e.g., increased noise, reduced hearing). These materials are often required to be sandwiched between layers of knit fiber material so as to further compound the breathability and auditory issues attributable to these materials. As such, the articles of the present application provide for targeted particulate protection, features not found in conventional devices.

The articles of the present application may further be manufactured by providing one or more structural sections, such as those described above, and patterning one or more protective sections connected with the one or more structural sections so as to form an article of clothing. In some embodiments, the article may be formed such that the protective sections are patterned as distinct sections or elements, while, in other embodiments, the protective sections may be formed such that the transition from structural sections to protective sections is indistinguishable. In some embodiments, the protective sections may be detachable from the structural sections such that the articles of the present disclosure may operate as modular components. By way of example, in some instances, increased particulate protection may be required for the neck of the user. In such an example, a shirt without a neck section (e.g., particulate protective shirt 200) may be fitted with a neck section (e.g., neck section 110 in FIG. 1A) so as to provide the required protection for the user's neck.

Many modifications and other embodiments of the inventions set forth herein will come to mind to one skilled in the art to which these inventions pertain having the benefit of the teachings presented in the foregoing descriptions and the associated drawings. Although the figures only show certain components of the methods and systems described herein, it is understood that various other components may also be part of any article described herein. In addition, the method described above may include fewer steps in some cases, while in other cases may include additional steps. Modifications to the steps of the method described above, in some cases, may be performed in any order and in any combination.

Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A particulate protective article comprising:
one or more structural sections, wherein each structural section is comprised of a primary material; and
one or more protective sections connected with the one or more structural sections so as to form an article of clothing, wherein each protective section is comprised of a particulate blocking or filtering material,
wherein, in an instance in which the article is worn by a user, the one or more protective sections are configured to shield one or more corresponding areas of the user's superficial lymphatic system from particulate matter.

2. The particulate protective article according to claim 1, wherein the article is formed as a shirt configured to at least partially cover the user's torso.

3. The particulate protective article according to claim 2, wherein the one or more protective sections are located so as to shield a front portion of the user's torso from particulate matter.

4. The particulate protective article according to claim 2, wherein the one or more protective sections are located so as to shield the user's armpits from particulate matter.

5. The particulate protective article according to claim 2, wherein the one or more protective sections are located so as to shield the user's neck from particulate matter.

6. The particulate protective article according to claim 1, wherein the article is formed as an undergarment configured to at least partially cover the user's groin.

7. The particulate protective article according to claim 6, wherein the one or more protective sections are located so as to shield the user's groin and lower abdomen from particulate matter.

8. The particulate protective article according to claim 7, wherein the one or more protective sections are located so as to shield at least a portion of the user's buttocks from particulate matter.

9. The particulate protective article according to claim 1, wherein the primary material is melt-resistant.

10. The particulate protective article according to claim 1, wherein the article is further configured to interface with one or more additional articles of clothing so as to form a protective uniform.

11. A method of manufacturing a particulate protective article, the method comprising:
providing one or more structural sections, wherein each structural section is comprised of a primary material; and
patterning one or more protective sections connected with the one or more structural sections so as to form an article of clothing, wherein each protective section is comprised of a particulate blocking or filtering material,
wherein, in an instance in which the article is worn by a user, the one or more protective sections are configured to shield one or more corresponding areas of the user's superficial lymphatic system from particulate matter.

12. The method according to claim 11, wherein the article is formed as a shirt configured to at least partially cover the user's torso.

13. The method according to claim 12, wherein the one or more protective sections are located so as to shield a front portion of the user's torso from particulate matter.

14. The method according to claim 12, wherein the one or more protective sections are located so as to shield the user's armpits from particulate matter.

15. The method according to claim 12, wherein the one or more protective sections are located so as to shield the user's neck from particulate matter.

16. The method according to claim 11, wherein the article is formed as an undergarment configured to at least partially cover the user's groin.

17. The method according to claim 16, wherein the one or more protective sections are located so as to shield the user's groin and lower abdomen from particulate matter.

18. The method according to claim 17, wherein the one or more protective sections are located so as to shield at least a portion of the user's buttocks from particulate matter.

19. The method according to claim 11, wherein the primary material is melt-resistant.

20. The method according to claim 11, wherein the article is further configured to interface with one or more additional articles of clothing so as to form a protective uniform.
